(19) United States
(12) Patent Application Publication
(10) Pub. No.: US 2023/0124344 A1
(43) Pub. Date: Apr. 20, 2023

(54) CLAMPING DEVICE AND INTERFACE FOR AN ELECTROCHEMICAL CELL STACK

(71) Applicant: Enevate Corporation, Irvine, CA (US)

(72) Inventors: Sanjaya D. Perera, Irvine, CA (US); Xianyang Li, Irvine, CA (US); Eric Ibarra, Irvine, CA (US); Todd Tatar, Irvine, CA (US); Benjamin Park, Irvine, CA (US); Kirk Shockley, Irvine, CA (US)

(21) Appl. No.: 17/505,177

(22) Filed: Oct. 19, 2021

(51) Int. Cl. H01M 10/04; H01M 50/204; H01M 4/134; H01M 10/48; H01M 10/42; H01M 4/133; H01M 4/38; H01M 4/587; H01M 10/0525

(52) U.S. Cl. CPC H01M 10/0481; H01M 50/204; H01M 4/134; H01M 10/482; H01M 10/4257; H01M 4/133; H01M 4/386; H01M 4/587; H01M 10/0525; H01M 2220/20; H01M 2010/4271; H01M 2004/027

(57) ABSTRACT

A clamping device for a multilayered battery comprising one or more electrochemical cells is provided. The clamping device can include one or more plates, guided elastic members, and/or one or more layers of an interfacial material, such as foam pads or papers, to provide distributed pressure across one or more surfaces of the multilayered battery during cell formation and/or cycling. A compression plate is employed to provide a compressive force to compress the elastic members to a predetermined length, at which the position of the elastic members can be fixed.

### CROSS-REFERENCE TO RELATED APPLICATIONS

N/A

### FIELD

Aspects of the present disclosure relate to clamping devices. More specifically, certain embodiments of this disclosure relate to methods and systems for clamping lithium (Li) ion cells with the use of an interfacial material to achieve uniform pressure distribution on cell surface.

### BACKGROUND

A lithium ion battery typically includes a separator and/or electrolyte between an anode and a cathode. In some of batteries, the separator, cathode and anode materials are individually formed into sheets or films. Sheets of the cathode, separator and anode are subsequently stacked or rolled with the separator separating the cathode and anode (e.g., electrodes) to form the battery. For the cathode, separator and anode to be rolled, each sheet must be sufficiently deformable or flexible to be rolled without failures, such as cracks, brakes, mechanical failures, etc. Typical electrodes include electrochemically active material layers on electrically conductive metals (e.g., aluminum and copper). For example, carbon can be deposited onto a current collector (e.g., a copper sheet) along with an inactive binder material. Carbon is often used because it has excellent electrochemical properties and is also electrically conductive. Electrodes can be rolled or cut into pieces which are then layered into stacks. The stacks are of alternating electrochemically active materials with the separator between them.

In order to increase the volumetric and gravimetric energy densities of lithium-ion batteries, silicon has been proposed as the active material for the negative electrode. However, during cycling, silicon particles in the anode active material expand upon charging. This expansion can deform the metal foil used as current collectors. Since the layers of the cell stack are confined in a tight region, the expansion can result in warping or deformation of the metal foil, thus reducing the contact area between layers in the battery stack. As a result, the ability of a battery to accept and release electrical charge may be severely affected. Thus, preventing the electrode from deformation could serve to reduce the irreversible capacity and improve cycle life.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

Systems and/or methods for a clamping device for lithium (Li) ion cells, employing an interfacial material and/or a compression plate, to achieve uniform pressure distribution on cell surfaces are disclosed, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIGS. 1A and 1B illustrate an example clamping device for a multilayer battery, in accordance with an example embodiment of the disclosure.

FIGS. 2A and 2B illustrate another example clamping device for a multilayer battery, in accordance with an example embodiment of the disclosure.

FIGS. 3A to 3D illustrate another example clamping device for a multilayer battery, in accordance with an example embodiment of the disclosure.

FIGS. 4A and 4B illustrate another example clamping device for a multilayer battery, in accordance with an example embodiment of the disclosure.

FIGS. 4C and 4D illustrate an example multiple clamping device stack, in accordance with an example embodiment of the disclosure.

FIGS. 5A and 5B illustrate another example clamping device for a multilayer battery, in accordance with an example embodiment of the disclosure.

FIG. 6 illustrates specification of a pressure profile paper, in accordance with an example embodiment of the disclosure.

FIGS. 7A to 7E illustrate another example clamping device for a multilayer battery, in accordance with an example embodiment of the disclosure.

FIG. 8 illustrates an example method of reducing deformation of an electrode in a multilayer battery, in accordance with an example embodiment of the disclosure.

FIG. 9 illustrates example control circuitry to control pressure associated with an example clamping device, in accordance with an example embodiment of the disclosure.

### DETAILED DESCRIPTION

Some rechargeable lithium-ion batteries include silicon (Si) dominant anodes comprising a silicon-carbon (Si—C) composite material coated on a copper (Cu) foil current collector. Such batteries may expand and contract during cycling (e.g., charging and discharging). Pressure within a cell stack (e.g., layers of a multilayer battery) plays a significant role achieving stable cycling performance with minimum capacity fade.

In disclosed examples, a clamping device is configured to create and/or maintain sufficient pressure on the layers of the multilayer battery. For example, the clamping device may consist of one or more plates, guided elastic members (e.g., springs), and/or one or more layers of an interfacial material (e.g., foam pads, papers, etc.) to provide distributed pressure across one or more surfaces of the cell stack during cell formation and/or cycling.

In some examples, the battery is arranged between two plates, one of which is positionable relative to the other. The positionable plate is configured to move in response to expansion of the battery during cycling. The disclosed clamping device facilitates uniform pressure distribution in the battery during cycling, and/or electrochemical pretreatment steps such as formation, by providing a substantially uniform force against the positionable plate by the elastic members.

In some examples, a compression plate is employed to provide a compressive force to compress the elastic members to a predetermined length, at which the position of the elastic members can be fixed. This can be achieved by securing coupling members to a plate of the one or more plates, the coupling members configured to support the elastic members at an end opposite the plate. Thus, when the battery expands, the positionable plate resists expansion of the battery.

In some examples, one or more spacers are provided between the compression plate and the positionable plate for efficiency and ease of use. As the compression plate is forced toward the positionable plate, the spacers determine a distance at which the compression plate stops, corresponding to an amount of compression of the elastic members. For example, in some embodiments, only one of the first and the second plates is movable as the cell stack expands. In other embodiments, both plates are movable as the cell stack expands. The variation of the distance between the first and second plates can correlate with the expansion of the cell stack.

In some examples, a position sensor is used during the initial configuration to determine a distance between the compression plate and the positional plate, where the measured distance is used when adjusting the pressure exerted by the positional plate on the cell stack.

In some examples, a pressure or force sensor is used during the initial configuration to determine a certain distance between the compression plate and the positional plate to achieve a predetermined amount of pressure applied by the positional plate on the cell stack.

In an example, the battery may consist of a single layer or a multilayer cell stack, which may include one or more of Si, graphite, a Si-graphite material, carbon, and/or one or more of a composite anode and/or cathode.

During electrochemical cycling (e.g., formation, charging, discharging, normal operation inside a device or vehicle, etc.), one or more layers of the battery and/or cell stack may experiences physical changes in one or more of the X, Y, or Z dimensions. When the battery is confined between one or more layers of the interfacial material (e.g., paper or foam pads) compressed against the clamping plates enhances uniform pressure distribution on the battery. Uniform cell pressure on internal cell components from applied compressive forces significantly improves mechanical integrity of the electrodes and/or separator material during cycling and improves performance such as durability/cycle fade.

The elastic member can be configured to be compressed during the charging of the multilayered battery. As the battery expands against the positional plate and the elastic member is compressed, the pressure on the battery exerted by the first and second plates is reduced relative to a system without elastic members where the first and second plates are both in a fixed position relative to the other plate. In some instances, the use of an elastic member and positional plate can result in a substantially constant pressure applied to the layers of the multilayered battery, thereby reducing the thickness variation and/or deformation of the battery due to non-uniform expansion. Further, use of an elastic member and positional plate allows for the pressure applied to the battery to be configurable by adjusting the characteristics of the elastic member.

The interfacial material can be configured to improve uniformity of pressure applied to the multilayered battery. In some instances, the interfacial material can be configured to reduce the pressure variation across the surface of the battery due to non-uniform properties of the battery yet still apply more pressure in raised regions of the cell, thereby reducing the thickness variations and/or deformation of the battery due to non-uniform expansion. Further, as an elastic member and an interfacial material are used, it is advantageous to have the elastic member apply a first force against the battery, where a second force applied by the interfacial member against the battery is smaller than the first force, and therefore primarily used to adjust the uniformity of pressure across the battery surface, and/or to make fine adjustments to the total force applied to the battery.

In some examples, a separator may be included with adhesive or supporting material coatings that can interface with one or more battery electrode. Providing cell pressure as disclosed herein facilitates both physiochemical and electrochemical interfacing of supporting layer(s) that include the separator with electrodes and/or electrolytes, which may improve battery performance.

For instance, a uniform distance between electrode interfaces and the separator is beneficial, which avoids gaps between the separator surface and the electrode surface. Providing cell pressure as disclosed herein facilitates this uniformity and interface contact, which may improve battery performance.

Uniform pressure distributed across the surfaces of the cell stack contributes to uniform electrolyte distribution, and may avoid the formation of “dry spots” (e.g., less wetted areas) during cell testing. Preventing dry spots is useful, as the phenomenon plays a significant role in improving overall battery performance.

Application of uniform compressive pressures across the entire cell surface(s) can be effected by different numbers or types of interfacial materials, such as papers or foam pads, or combinations of paper and foam pads. For example, thicknesses of one or more layers of the cell stack may vary, such as around electrode tabs, or on the surface itself. Adequate compressibility and flexibility of the paper (e.g., 350 μm) and/or the foam pad (e.g., >0.1 mm) introduces uniform pressure on the battery surface(s), despite the presence of thickness variations in one or more layers (e.g., electrode, separator, etc.) caused by defects and/or processing deformations.

In some examples, the clamping device may confine the battery between two layers of interfacial material, the clamping device being equipped with one or more springs (e.g., 1. 2, 3, 4, 5, 6, 7, 8, or more springs) to facilitate application of uniform pressure across the battery surface(s).

Clamping the cell may be useful in a variety of applications, such as battery formation, cycling, electrochemical testing, and/or operation within a device or vehicle (such as operation within a module or pack), as a list of non-limiting examples. The disclosed clamping device configuration may be the same for different applications, or may be modified to suit conditions of the particular application. For each disclosed application, uniform pressure distribution across the battery may help to eliminate electrode cracking, wrinkles, and/or other defects propagating on the clamped cell during formation, cycling, electrochemical testing, etc.

In disclosed examples, the number of elastic members, such a springs, being employed varies, and can be determined upon consideration of a number of factors, including type, capacity, and/or size of the battery, size of the clamping device, type and rating of the spring, amount of desired compressive force, as well as other characteristics, such as type, size and number of interfacial material layers used, temperature range, or device in which the battery is arranged, as a list of non-limiting examples.

Conventional anode electrodes in rechargeable lithium-ion cells typically have a specific capacity of approximately 200 milliamp hours per gram (including the metal foil current collector, conductive additives, and binder material). Graphite, the active material used in most lithium-ion battery anodes, has a theoretical energy density of 372 milliamp hours per gram (mAh/g). In comparison, silicon has a high theoretical capacity of 4200 mAh/g. Silicon compounds, however, tend to swell in excess of 300% upon lithium insertion. Because of this expansion, anodes that include silicon should be allowed to expand while maintaining electrical contact between the silicon particles. However, as an electrochemical cell stack expands, the expansion can be non-uniform, resulting in thickness variation in the battery and/or one or more layers, resulting in wrinkling and deformation.

Due to this swelling, batteries that contain an electrode with alloy materials as active materials often have less uniform expansion or swelling and, thus, a device for applying substantially uniform pressure in a controlled manner as disclosed herein is highly effective. These benefits are enhanced for cells where one or more electrodes utilize 50% or more of an alloy material (such as silicon) as an active material.

This disclosure provides examples of clamping device(s) for a single- or multilayer electrochemical cell stack configured to reduce deformation of an expanding layer upon formation, charging, and/or testing. The layers of the battery cell stack can include one or more of graphite, silicon-based, tin-based, or other alloy-based electrodes.

In some examples, one of the first and second plates can be movable away from the other plate. For example, at least one of the first and second plates can be movable about the coupling member. If at least one of the first and second plates were not movable away from the other plate, the first and second plates can exert an increasing pressure onto the cell stack upon expansion of the cell stack during charging. Left uncontrolled, if a high enough pressure is reached, the cell stack could be damaged, e.g., shorting of the cell stack. However, in certain embodiments, because at least one of the first and second plates can be movable away from the other plate, some of the pressure exerted by the first and second plates onto the cell stack can be relieved and also controlled.

In some examples, the space between the first and second plates can be sized to receive more than one battery or cell stack. For example, a plurality of batteries can be placed side by side or stacked on top of each other between the first and second plates. In such examples, multiple batteries can utilize the same clamping device (e.g., the same elastic member to maintain similar or substantially the same set pressures on the cell stacks). Furthermore, the clamping device can also include more than the first and second plates, e.g., multiple plates stacked on top of each other. The space between two plates can be sized to each receive at least one battery. In such examples, several battery can also utilize the same elastic member. Thus, a plurality of batteries can be placed between the first and second plates with or without additional plates and/or spacers.

In some examples, the coupling member can be any extending structure having a longitudinal length capable of coupling two plates. In some instances, the coupling member is fixed or seated in the two plate. For example, the coupling member may be a post/rod with one end fixed in a first or a second plate, or the coupling member may be a screw or a post with a threaded portion screwed directly into the first or the second plate. In other examples, the coupling member extends through a first bore in the first plate and a second bore in the second plate. In some examples, the coupling member may be a fastener such as a screw, a bolt, a nut, a rod/post, a spring clamp, or a C-clamp. In some examples, the rod/post may or may not comprise a threaded portion or a textured portion. In other examples, the coupling member may comprise a clamp, e.g., a C-clamp. In some examples, the clamping device may comprise one or more coupling members.

The elastic member can have a given spring constant, and may be an expansion member or a compression member. In some embodiments, the elastic member may be an expansion member, which is configured to pull the first and the second plates toward each other or exert force on the two plates to cause the plates to be pushed toward each other. In some examples, the elastic member may comprise a spring (including expansion spring and compression spring), a plunger, an elastic band, a pneumatic piston, a hydraulic piston, a pneumatic or hydraulic bladder, or foam. In some examples where multiple elastic members are employed, one elastic member may have a spring constant different than another elastic member.

In some examples, the elastic band (e.g., a rubber band) can be disposed around the first and second plates. The elastic band can be configured to allow the at least one of the first and second plates to move away from the other plate upon expansion of the electrochemical cell stack. At least one of the first or second plates can be configured to compress the elastic band to set an applied pressure on the cell stack.

In another example, the coupling member can include parts of a C-clamp holding two plates at a fixed distance relative to each other.

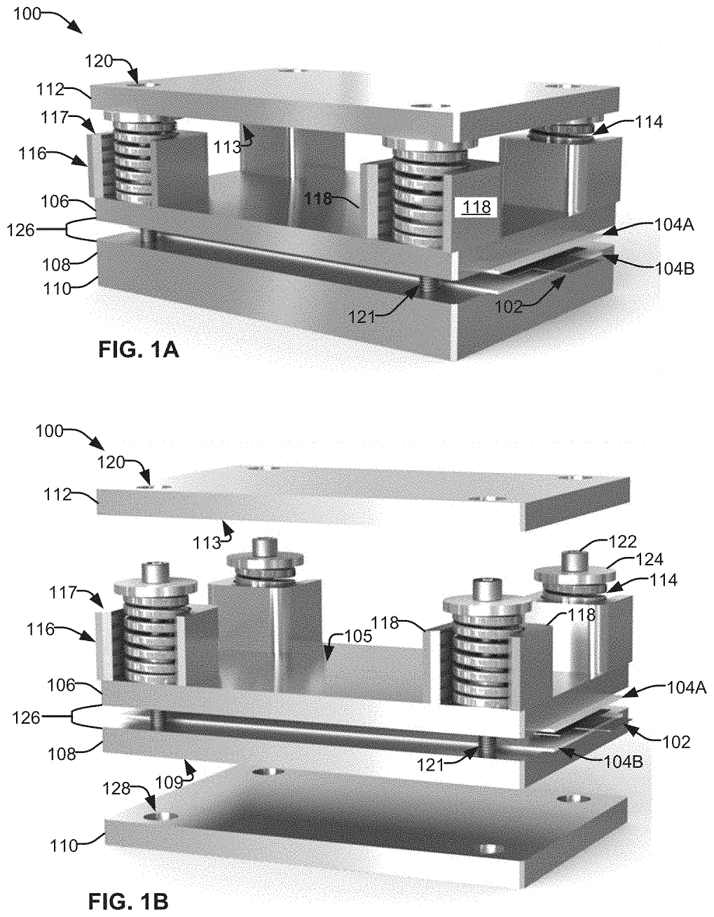

FIGS. 1A and 1B illustrate an example clamping device 100 in accordance with certain embodiments described herein. As shown, the clamping device 100 is used to confine and exert pressure on a multilayer lithium ion battery 102 during cycling. The clamping device 100 can include a first plate 106 (e.g., a positionable plate) and a second plate 108. The first plate 106 can be positionable relative to the second plate 108 such that a space 126 between the first plate 106 and the second plate 108 is sized to receive the multilayered battery 102. The clamping device 100 can also include one or more coupling members 121 (e.g., a threaded bolt) coupling the first plate 106 to the second plate 108, arranged at corners of the device. At least one of the first 106 and second 108 plates can be movable away from the other plate. For example, the first plate 106 may move away from the second plate 108 guided by the coupling members 121 as the battery 102 expands. In some examples, the second plate 108 may also be movable about the coupling member 121. For example, the second plate 108 can move away from the first plate 106 along the coupling member 121 as the battery 102 expands.

The coupling member 121 can have a first end portion (on an end portion opposite to 122) and a second end portion 122 (e.g., a bolt head). The clamping device 100 can further include an elastic member 114 (e.g., a spring) disposed between the first end portion and the second end portion 122. As the battery 102 within the clamping device 100 expands on cycling, the elastic member 114 can allow the first plate 106 to move along the coupling member 121 to a distance (e.g., correlating to the expansion of the battery 102) relative to the second plate 108. The variation of the distance between the first plate 106 and the second plate 108 (space 126) can correlate with the expansion of the battery 102.

A washer 124 can be configured to compress the elastic member 114 in response to compression plate 112 applying force against the washer 124 toward the first plate 106. Thus, when a battery 102 is arranged between the first and second plates, the force from the compression plate 112 causes the elastic members 114 to compress until a surface 113 of the compression plate 112 makes contact with a surface 117 of one or more spacers 116. As a result, the battery 102 occupies a space 126 between plates.

In some examples, the compression plate 112 includes one or more openings 120 corresponding with a bolt or bolt head 122 of the coupling member 121. This arrangement allows the compression plate 112 to fully compress the elastic members 114, while providing access to each bolt 122. Thus, with the compression plate 112 in place and the elastic members 114 at a desired compression amount, the bolts 122 can be manipulated (e.g., tightened and/or loosened) to drive the coupling members 121 into the first and/or second plates 106, 108 to secure the coupling members 121 to the second plate 108 (e.g., via threaded bores), thereby fixing the relative positions of the first and second plates.

Each bolt 122 can be tightened or loosened independently. Thus, each elastic member 114 can be compressed independently to set an applied pressure on the battery that can vary across the battery 102 to account for uneven thickness, expansion and/or contraction of the battery 102. In some examples, the length of each elastic member 114, for example, can be measured with calipers to increase consistency. Additionally or alternatively, the use of the compression plate 112 applying a force against each washer 124 may ensure desired spring compression. Although illustrated as arranged in corners, one or more of the coupling members 121 may be arranged at various locations about the device 100, in addition to or instead of the corners.

The battery 102 thus occupies the space 126, and provides a force pushing against the first plate 106 and, therefore, the elastic members 114. In particular, the first plate 106 is configured to allow for movement relative to the second plate 108 in a substantially vertical direction. As disclosed herein, as the battery 102 expands or contracts during cycling, the first plate 106 can move, guided by the one or more coupling members 121 extending through one or more bore holes of the first plate 106.

By applying a pressure that reacts to the thickness variations of the battery 102 upon expansion, more consistent electrochemical behavior can result. In some embodiments, the variations in pressure can be reduced so that the applied pressure slightly varies or is substantially constant.

As shown in the example of FIGS. 1A and 1B, the spacers 116 are a U-shaped structure, with one or more walls 118 (e.g., internal and/or external walls), arranged on a surface 105 of the first plate 106 and configured to fully or partially enclose the coupling members 121 and/or the elastic members 114.

The dimensions of the spacers 116 (e.g., height, placement relative to the elastic members 114, etc.) can vary based on one or more factors (e.g., amount of compression required, type of battery, particular application, etc.). In some examples, the spacers 116 are fixed to the surface 105. In some examples, the spacers 116 are removable from the surface 105. In some examples, the spacers 116 are fixed to the surface 113 of the compression plate 112.

In some examples, a fourth base plate 110 is provided to support the second plate 108, arranged adjacent a surface 109 of the second plate 108 opposite the battery 102. The base plate 110 may include one or more openings 128 to accommodate extension of coupling members 121 beyond the surface 109. In some examples, once the coupling members 121 are in place, the compression plate 112 and/or the base plate 110 can be removed.

As shown, the clamping device 100 is a stand-alone device configured to contain a single battery 102. In some examples, two or more batteries can be contained within a clamping device. In some examples, multiple clamping devices can be arranged in tandem, either to support a large battery, and/or to connect multiple batteries contained in a number of clamping devices. This flexibility in arrangement allows for scaling of battery power, or accommodation of various geometries within a particular application, for example.

After formation, the multilayer battery contained within the first and second plates can be employed as a module arranged within an object (e.g., a vehicle) to provide battery power. Further, multiple modules can be arranged as a pack for providing increased power outputs and/or increasing total energy storage.

In the example of FIGS. 1A and 1B, four each of the coupling members 121, the elastic members 114, spacers 116, and washers 124 are employed. However, in some examples, one, two, three, five, six, seven, eight, or more of each of the coupling members 121, the elastic members 114, spacers 116, and washers 124 are employed. In some examples, the washers 124 are replaced by one or more plates configured to force compression of two or more elastic members simultaneously. A more expansive plate may be useful in applications employing an air bladder to compress the elastic members.

In the example of FIGS. 1A and 1B, the clamping device 100 includes an interfacial material 104 between the first 106 and second 108 plates. For example, a first layer of interfacial material 104A can be placed between the battery 102 and the first plate 106, and/or a second layer of interfacial material 104B can be placed between the battery and the second plate 108. The interfacial material 104 can conform to the surfaces of the battery 102, and can be made of a variety of materials, including, but not limited to, polyethylene sheet, polypropylene sheet, PTFE sheet, paper, paperboard, natural rubber, silicone rubber, reinforced (such as fiber) polymer (such as rubber), foam, a pneumatic or hydraulic bladder, or felt. The interfacial material 104 can aid in even distribution of applied pressure from the compression plate, for example. In addition, the interfacial material 104 can reduce and/or substantially eliminate damage caused by the force of the elastic member 114 compressing on the thickest portion of the battery 102. This interfacial material 104 may also allow additional adjustment to account for cell thickness variation which can result in non-uniform pressure during cycling. Each layer of interfacial material may comprise of multiple layers of one or more materials selected to distribute pressure across the battery.

In disclosed examples, the pressure on the battery 102 exerted by the first 106 and second 108 plates can be reduced. In some embodiments, the reduced increase in pressure can result in applied pressure on the battery 102 that varies slightly or that is substantially constant. In some embodiments, if the applied pressure is too high (e.g., greater than about 400 psi), the electrolyte may be squeezed out of the battery 102. Additional damage can also occur to the components of the battery 102, including shorting of the battery 102. Conversely, in some embodiments, if the applied pressure is too low (e.g., less than a pressure between about 10 and 40 psi for certain pouch cells), the warping of the current collector may not be contained and the electrode foils of the current collector may deform. In various embodiments, the applied pressure on the battery 102 can be between about 25 psi and about 350 psi, between about 25 psi and about 250 psi, between about 50 psi and about 200 psi, between about 10 psi and about 400 psi, between about 20 psi and about 400 psi, between about 30 psi and about 400 psi, between about 40 psi and about 300 psi, between about 50 psi and about 300 psi, between about 60 psi and about 300 psi, between about 70 psi and about 300 psi, between about 80 psi and about 300 psi, between about 90 psi and about 300 psi, or between about 100 psi and about 200 psi.

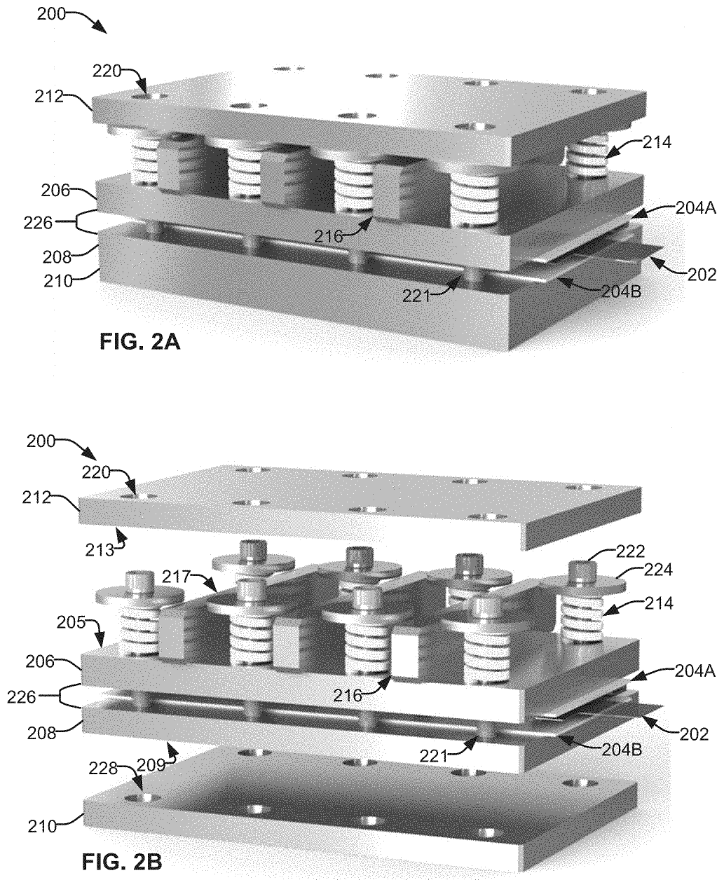

FIGS. 2A and 2B illustrate an example clamping device 200 in accordance with certain embodiments described herein. As shown, the clamping device 200 is used to confine and exert pressure on the multilayer battery 202 during cycling. The clamping device 200 can include a first plate 206 and a second plate 208. The first plate 206 can be positionable relative to the second plate 208 such that a space 226 between the first plate 206 and the second plate 208 is sized to receive the multilayered battery 202. The clamping device 200 can also include one or more coupling members 221 (e.g., a threaded bolt) coupling the first plate 206 to the second plate 208, arranged at corners and/or edges of the device. At least one of the first 206 and second 208 plates can be movable away from the other plate. For example, the first plate 206 may move away from the second plate 208 guided by the coupling members 221 as the battery 202 expands. In some examples, the second plate 208 may also be movable about the coupling member 221. For example, the second plate 208 can move away from the first plate 206 along the coupling member 221 as the battery 202 expands.

Similar to the clamping device 100, the coupling member 221 can have a first end portion (on an end portion opposite to 222) and a second end portion 222 (e.g., a bolt head). An elastic member 214 (e.g., a spring) is disposed between the first end portion and the second end portion 222, allowing the second plate 208 to move along the coupling member 221 relative to the first plate 206 in response to expansion of the battery 202. Further, a washer 224 is configured to compress the elastic member 214 in response to compression plate 212 applying force against the washer 224 toward the first plate 206. Thus, when a battery 202 is arranged between the first and second plates, the force from the compression plate 212 causes the elastic members 214 to compress until a surface 213 of the compression plate 212 makes contact with a surface 217 of one or more spacers 216. As a result, the battery 202 occupies a space 226 between plates.

In some examples, the compression plate 212 includes one or more openings 220 corresponding with a bolt or bolt head 222 of the coupling member 221. This arrangement allows the compression plate 212 to fully compress the elastic members 214, while providing access to each bolt 222.

As shown in the example of FIGS. 2A and 2B, the spacers 216 are a generally rectangular-shaped structure, with one or more walls (e.g., internal and/or external walls), arranged on a surface 205 of the first plate 206 and configured to fully or partially cross a width of the first plate 206. However, the spacers 216 can have any size or geometry suitable to support the first plate 206 (e.g., cylindrical, U-shaped, L-shaped, etc.). As shown, the spacers 216 are arranged between two or more of the coupling members 221 and/or the elastic members 214. In some examples, one or more of the spacers 216 is arranged to fully or partially cross a length of the first plate 206.

The dimensions of the spacers 216 (e.g., height, placement relative to the elastic members 214, etc.) can vary based on one or more factors (e.g., amount of compression required, type of battery, particular application, etc.). In some examples, the spacers 216 are fixed to the surface 205. In some examples, the spacers 216 are removable from the surface 205. In some examples, the spacers 216 are fixed to the surface 213 of the compression plate 212.

In some examples, a fourth base plate 210 is provided to support the second plate 208, arranged adjacent a surface 209 of the second plate 208 opposite the battery 202. The base plate 210 may include one or more openings 228 to accommodate extension of coupling members 221 beyond the surface 209. In some examples, once the coupling members 221 are in place, the compression plate 212 and/or the base plate 210 can be removed. Similar to the clamping device 100, the clamping device 200 can operate a single device or be arranged with and/or coupled to a number of other batteries and/or clamping devices.

In the example of FIGS. 2A and 2B, the clamping device 200 includes an interfacial material 204 between the first 206 and second 208 plates. For example, a first layer of interfacial material 204A can be placed between the battery 202 and the first plate 206, and/or a second layer of interfacial material 204B can be placed between the battery and the second plate 208. The interfacial material 204 can conform to the surfaces of the battery 202, and aid in even distribution of applied pressure from the compression plate, for example. Each layer of interfacial material may comprise of multiple layers of one or more materials selected to distribute pressure across the battery.

In some examples, for one or both of the clamping devices 100 and 200, the first plate can be made of substantially the same material as that of the second plate (and/or the compression plate or base plate). In other examples, the first plate can be made of different material than that of the second plate (and/or the compression plate or base plate). The materials can include metal (e.g., carbon steel, aluminum, metallic alloys, carbon fibers, etc.), a polymer (e.g., polypropylene, an epoxy, etc.) and/or reinforced polymer. One or more of the plates and/or materials can also include an insulating material. The cross-sectional shape of at least one of the first and second plates can be square, rectangular, circular, ovular, or polygonal (e.g., pentagonal, hexagonal, octagonal, etc.). The first plate can be positionable relative to the second plate such that there is a space between the first and second plates. Because the space can be sized to receive an electrochemical battery, the dimensions of the first and second plates can be sized and shaped so as to be able to house a battery between the first and second plates. Thus, the dimensions of the first and second plates and the space between can depend on the size and shape of the battery.

Furthermore, the thicknesses of the first and second plates can be sized to reduce bending of the first and second plates upon charging of the battery. For example, the thicknesses of the first and second plates can be between about 0.5 cm and about 0.8 cm, e.g., about 0.6 cm, about 0.65 cm, about 0.7 cm, about 1 cm, about 2 cm, between about 1 cm and about 2 cm, or between about 0.5 cm and about 2 cm. In some examples, the shape and dimensions of the first plate can be substantially the same as the shape and dimensions of the second plate. In other examples, the shape and dimensions of the first plate can be different than the shape and dimensions of the second plate.

In some examples, an actuator (e.g. a passive and/or actively controllable actuator, such as a spring, a plunger, an elastic band, a pneumatic or hydraulic piston, a motorized screw or piston, foam, an air or hydraulic bladder (or other type of pneumatic bladder), an air or hydraulic piston, etc.) or any combination of controllable force devices can be employed to facilitate uniform pressure distribution of the compression plate and/or the first plate and/or to otherwise control the pressure applied to the batteries. For example, an actuator can be used as a compliment to or a substitute for one or more of the elastic members. For instance, use of an air bladder may remove reliance on spacers, as the volume of the air bladder can be optimized to maintain one or more dimensions once compressed a desired amount. In other words, as a compressive force is applied to one or more air bladders (e.g., arranged between a compression plate and the first plate), the air bladders may compress in a first dimension (perpendicular to a plane in which the one or more plates exist), and expand in a second dimensions (coplanar with the one or more plates). Once the air bladders reach a desired first or second dimension, one or more coupling members (e.g., an elastic band, a C-clamp, etc.) can be employed to fix the relative positions of the plates containing the battery.

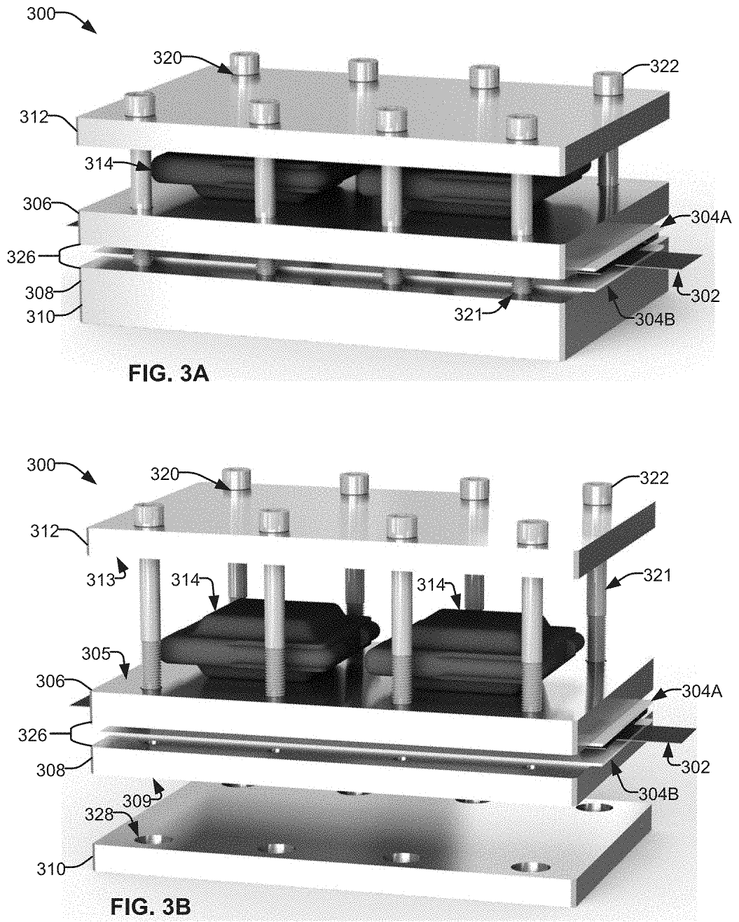

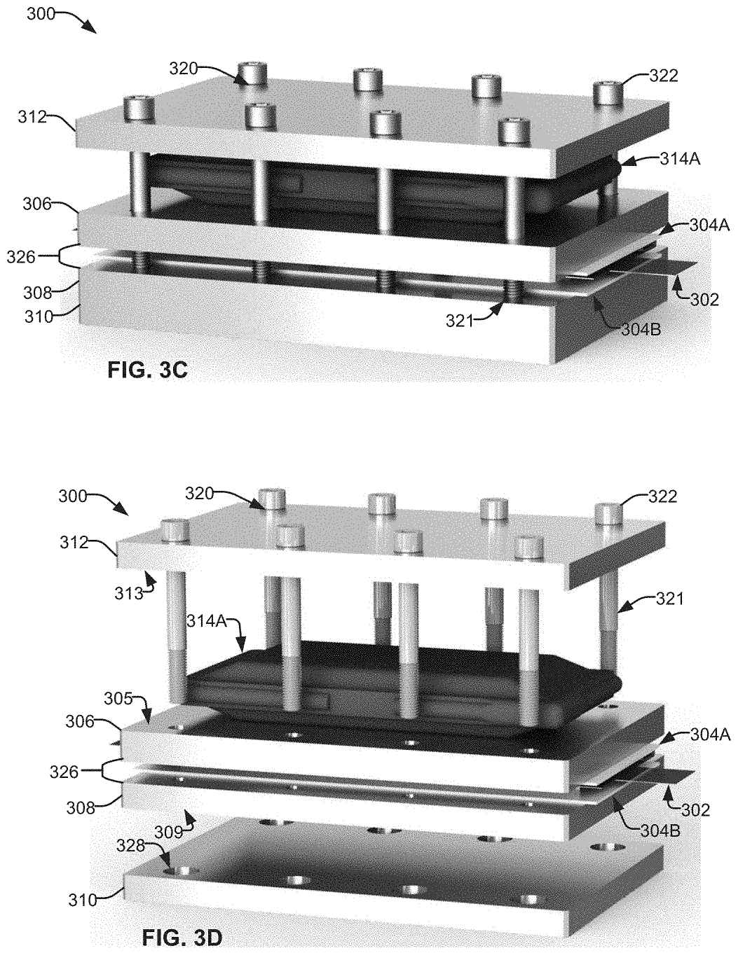

FIGS. 3A to 3D illustrate an example clamping device 300 having one or more features similar to clamping devices 100, 200, but employing one or more pneumatic or air bladders as an elastic member 314 (rather than a spring). As shown, the clamping device 300 is used to confine and exert pressure on a multilayer lithium ion battery 302 during cycling. The clamping device 300 can include a first plate 306 (e.g., a positionable plate) and a second plate 308. The first plate 306 can be positionable relative to the second plate 308 such that a space 326 between the first plate 306 and the second plate 308 is sized to receive the multilayered battery 302.

In some example, the clamping device 300 includes one or more layers of an interfacial material 304A, 304B, which can be placed between the battery 302 and the first plate 306 or the second plate 308, respectively. The interfacial materials 304A, 304B can conform to the surfaces of the battery 302, and aid in even distribution of applied pressure from the compression plate, for example. Each layer of interfacial material may comprise of multiple layers of one or more materials selected to distribute pressure across the battery.

The clamping device 300 can also include one or more coupling members 321 (e.g., a threaded bolt) coupling the first plate 306 to the second plate 308, arranged at corners and/or edges of the device. At least one of the first 306 and second 308 plates can be movable away from the other plate. For example, the first plate 306 may move away from the second plate 308 guided by the coupling members 321 as the battery 302 expands. In some examples, the second plate 308 may also be movable about the coupling member 321. For example, the second plate 308 can move away from the first plate 306 along the coupling member 321 as the battery 302 expands.

The coupling member 321 can have a first end portion (on an end portion opposite to 322) and a second end portion 322 (e.g., a bolt head). As shown, two air bladders 314 are disposed between the first end portion and the second end portion 322. As the battery 302 within the clamping device 300 expands on cycling, the air bladders 314 can allow the first plate 306 to move along the coupling member 321 to a distance (e.g., correlating to the expansion of the battery 302) relative to the first plate 306. The variation of the distance between the first plate 306 and the second plate 308 can correlate with the expansion of the battery 302.

A compression plate 312 can be configured to compress the air bladders 314 in response to an applied force against the air bladders 314 toward the first plate 306. Thus, when a battery 302 is arranged between the first and second plates, the force from the compression plate 312 causes the air bladders 314 to compress until the compression of the air bladders 314 reaches a predetermined size and/or pressure value. As a result, the battery 302 occupies a space 326 between plates.

In some examples, the compression plate 312 includes one or more openings 320 through which the coupling member 321 extends, revealing a bolt or bolt head 322. This arrangement allows the compression plate 312 to fully compress the air bladders 314, while providing access to each bolt 322. Thus, with the compression plate 312 in place and the elastic members 314 at a desired compression amount, the bolts 322 can be manipulated (e.g., tightened and/or loosened) to drive the coupling members 321 into the first and/or second plates 306, 308 to secure the coupling members 321 to the second plate 308 (e.g., via threaded bores), thereby fixing the relative positions of the first and second plates.

Each bolt 322 can be tightened or loosened independently. Thus, each air bladder 314 can be compressed independently to set an applied pressure on the battery 302 to reduce variations in pressure across the battery 302 due to expansion and/or contraction of the battery 302. In some examples, the distance between the compression plate 312 and the first plate 306 and/or a height of one or more of the air bladders 314, for example, can be measured with calipers to ensure consistency. Additionally or alternatively, the use of the compression plate 312 to apply a consistent force against each air bladder 314 may ensure a desired amount of compression.

The battery 302 thus occupies the space 326, and provides a force pushing against the first plate 306 and, therefore, the air bladders 314. In particular, the first plate 306 is configured to allow for movement relative to the second plate 308 in a substantially vertical direction. As disclosed herein, as the battery 302 expands or contracts during cycling, the first plate 306 can move, guided by the one or more coupling members 321 extending through one or more bore holes 320 of the first plate 306.

In some examples, a fourth base plate 310 is provided to support the second plate 308, arranged adjacent a surface 309 of the second plate 308 opposite the battery 302. The base plate 310 may include one or more openings 328 to accommodate extension of coupling members 321 beyond the surface 309.

The example clamping device 300 of FIGS. 3C and 3D employ a single air bladder 314A. However, three or more air bladders may be employed.

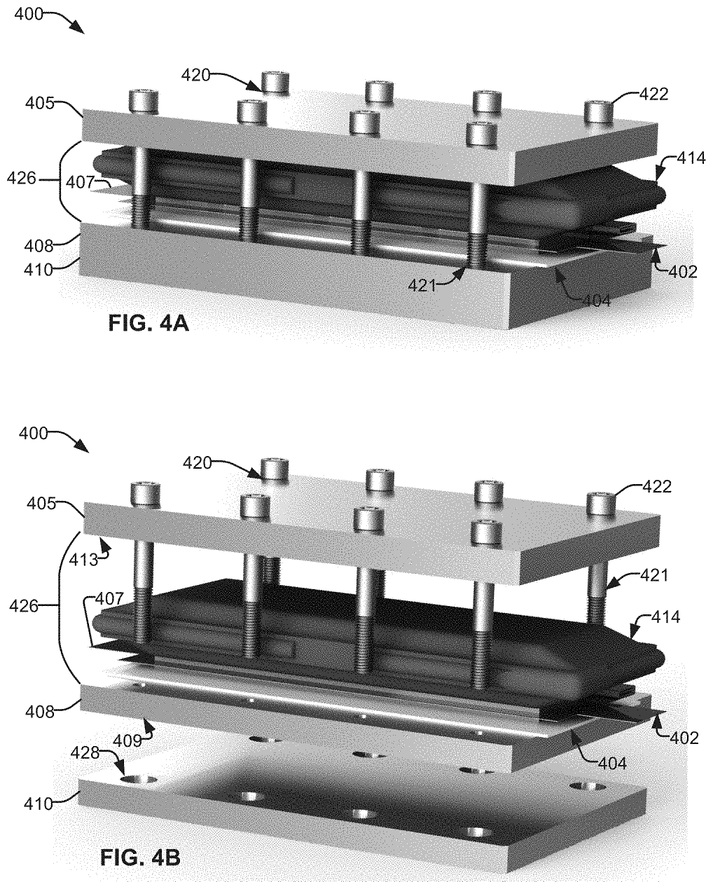

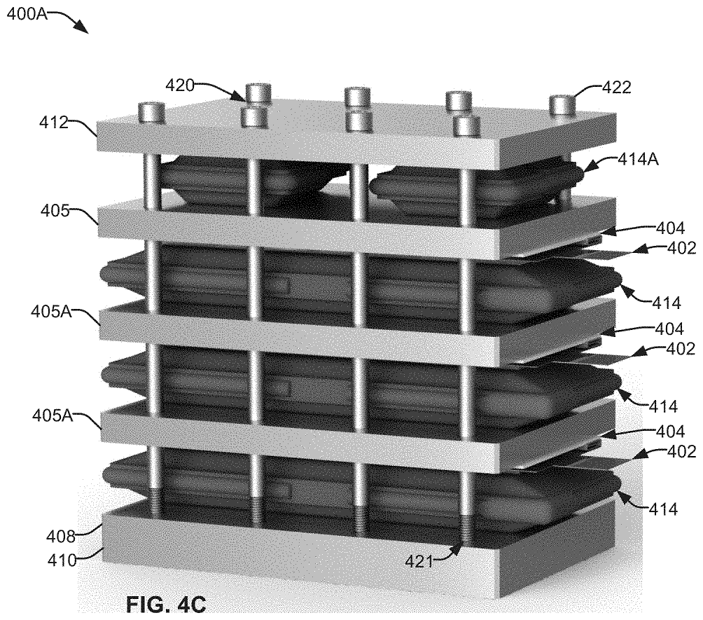

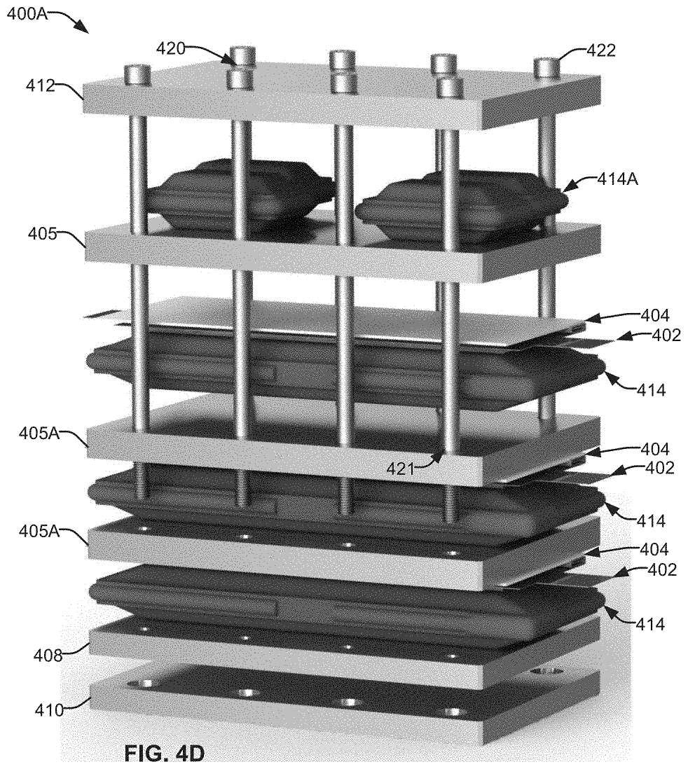

FIGS. 4A and 4B illustrate an example clamping device 400 having one or more features similar to clamping devices 100, 200, 300, employing one or more pneumatic or air bladders 414. As shown, the air bladder 414 is configured to apply pressure against an interfacial material 407. The interfacial material 407 can be similar to disclosed interfacial materials, such as a common type of material, or may contain a variety of materials, such as a metal, a polymer, a foam, a paper, or another suitable material. In some examples, no interfacial material 407 is used so that the air bladder 414 makes direct contact with the battery 402.

The clamping device 400 can include a stabilizing plate 405 and a second plate 408. The stabilizing plate 405 can be positionable relative to the second plate 408, such as by a compressive force against it, such that a space 426 between the stabilizing plate 405 and the second plate 408 is sized to receive the multilayered battery 402. The clamping device 400 can also include one or more coupling members 421 (e.g., a threaded bolt) coupling the stabilizing plate 405 to the second plate 408, arranged at corners and/or edges of the device.

In the example of FIG. 4A, the stabilizing plate 405 and the second 408 plate are in a fixed position relative to the other plate once the bolts 422 have been set. For example, as the battery 402 expands, the expansion forces the air bladder 414 to compress against the stabilization plate 405.

In some examples, the clamping device 400 includes one or more layers of an interfacial material 404, which can be placed between the battery 402 and the second plate 408. The interfacial material 404 can conform to the surfaces of the battery 402, and aid in even distribution of applied pressure from the compression plate, for example. Each layer of interfacial material (e.g., interfacial material 407 and/or interfacial material 404) may comprise of multiple layers of one or more materials selected to distribute pressure across the battery.

A coupling member 421 can have a first end portion (on an end portion opposite to 422) and a second end portion 422 (e.g., the bolt head). As the battery 402 within the clamping device 400 expands on cycling, the height of the air bladder 414 compresses a distance correlating to the expansion of the battery 402. The variation of the distance between the battery 402 and the second plate 408 can correlate with the expansion of the battery 402.

The stabilizing plate 405 can be configured to compress the air bladders 414 in response to an applied force against the air bladder 414 toward the battery 402. Thus, when the battery 402 is arranged between the air bladder 414 and the second plate 408, the force from the stabilizing plate 405 causes the air bladder 414 to compress until the compression of the air bladder 414 reaches a predetermined size and/or pressure value. As a result, the battery 402 occupies a space 426 between the battery 402 and the second plate 408.

In some examples, the stabilizing plate 405 includes one or more openings 420 through which the coupling member 421 extends, revealing a bolt or bolt head 422. This arrangement allows the stabilizing plate 405 to compress the air bladders 414, while providing access to each bolt 422. Thus, with the stabilizing plate 405 in place and the air bladder 414 at a desired compression amount, the bolts 422 can be manipulated (e.g., tightened and/or loosened) to drive the coupling members 421 into the second plate 408 to secure the coupling members 421 to the second plate 408 (e.g., via threaded bores), thereby fixing the relative positions of the first and second plates.

Each bolt 422 can be tightened or loosened independently. Thus, the air bladder 414 can be compressed independently to set an applied pressure on the battery 402 to reduce variations in pressure across the battery 402 due to expansion and/or contraction of the battery 402. In some examples, the distance between the stabilizing plate 405 and the second plate 408 (and/or a height of the air bladder 414), for example, can be measured with calipers to ensure consistency. Additionally, or alternatively, the use of the stabilizing plate 405 to apply a consistent force against the air bladder 414 may ensure a desired amount of compression.

The battery 402 and the air bladder 414 thus occupy the space 426, the battery 402 providing a force pushing against the second plate 408 and the air bladder 414 during expansion. In particular, the air bladder 414 is configured to compress in a substantially vertical direction. As disclosed herein, as the battery 402 expands or contracts during cycling, dimensions of the air bladder 414 can change.

In some examples, a fourth base plate 410 is provided to support the second plate 408, arranged adjacent a surface 409 of the second plate 408 opposite the battery 402. The base plate 410 may include one or more openings 428 to accommodate extension of coupling members 421 beyond the surface 409.

FIGS. 4C and 4D illustrate an example multiple clamping device stack 400A. As shown, the stack 400A incorporates one or more features of clamping devices 400, employing one or more pneumatic or air bladders 414 and/or 414A. As shown, the air bladders 414A is arranged between the compression plate 412 and a primary stabilizing plate 405. Between the primary stabilizing plate 405 and a secondary stabilizing plate 405A is one or more of a interfacial material layer 404, a battery 402, and/or an air bladder 414. This combination of components (and/or a different combination) may also be arranged between each of the secondary stabilizing plate 405A and/or a secondary stabilizing plate 405A and a second plate 408.

Although illustrated with two air bladders 414A between the compression plate 412 and the primary stabilizing plate 405, a single air bladder or two or more air bladders may be used. In some examples, the air bladders 414A may be additionally supported by one or more elastic members (e.g., elastic members 114, 214), or replaced by one or more elastic members, in accordance with disclosed examples.

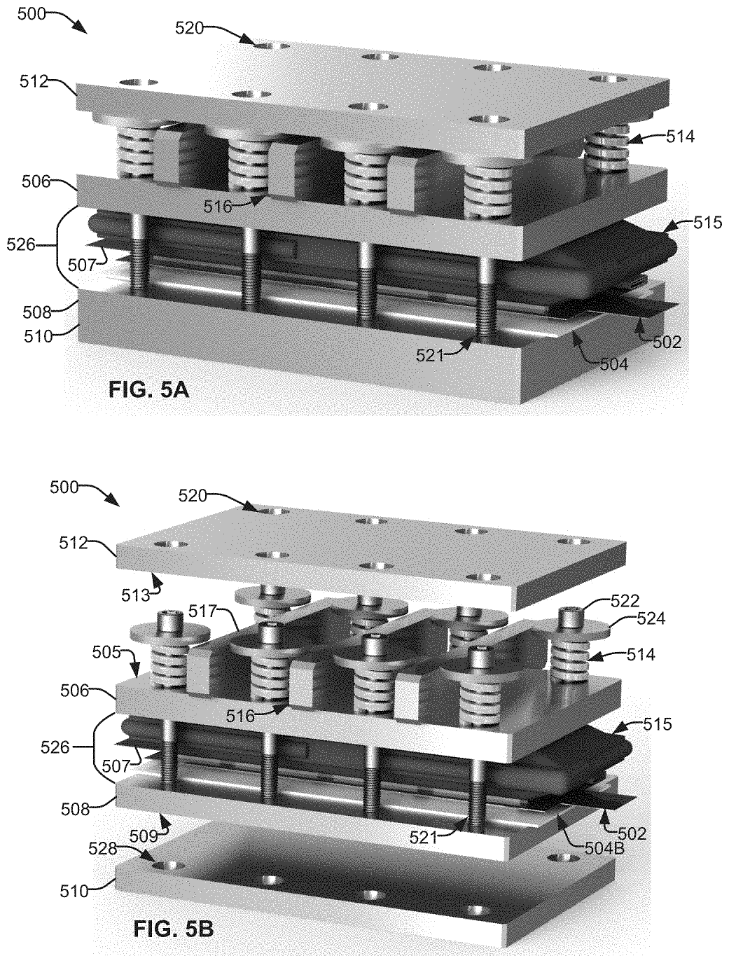

FIGS. 5A and 5B illustrate an example clamping device 500 having one or more features similar to clamping devices 100, 200, 300, 400 employing one or more pneumatic or air bladders 515 and/or one or more elastic members 514. The clamping device 500 can include a first plate 506 (e.g., a positionable plate) and a second plate 508. The first plate 506 can be positionable relative to the second plate 508. Between the first plate 506 and the second plate 508 is the air bladder 515 configured to apply pressure against a multilayer battery 502. A space 526 between the first plate 506 and the second plate 508 is sized to receive the multilayered battery 502.

In some examples, the clamping device 500 includes one or more layers of an interfacial material 507 and/or 504, which can be placed between the battery 502 and the air bladder 515 and/or between the battery 502 and the second plate 508, respectively. The interfacial materials 504, 507 can conform to the surfaces of the battery 502, and aid in even distribution of applied pressure from the compression plate 512 and/or the air bladder 515, for example. Each layer of interfacial material may comprise multiple layers of one or more materials selected to distribute pressure across the battery. In some examples, no interfacial material 507 is used so that the air bladder 515 makes direct contact with the battery 502.

The clamping device 500 can also include one or more coupling members 521 (e.g., a threaded bolt) coupling the first plate 506 to the second plate 508, arranged at corners and/or edges of the device. At least one of the first 506 and second 508 plates can be movable away from the other plate. For example, the first plate 506 and/or the air bladder 515 may move away from the second plate 508 (e.g., guided by the coupling members 521) as the battery 502 expands. In some examples, the second plate 508 may also be movable about the coupling member 521. For example, the second plate 508 can move away from the first plate 506 along the coupling member 521 as the battery 502 expands.

Additionally or alternatively, one or more washer 524 can be configured to compress the elastic members 514 and/or the air bladder 515 in response to compression plate 512 applying force against the washer 524 toward the first plate 506. The coupling member 521 can have a first end portion (on an end portion opposite to 522) and a second end portion 522 (e.g., a bolt head). The elastic members 514 (e.g., a spring) and the air bladder 515 are disposed between the first end portion and the second end portion 522, allowing the first plate 506 to move along the coupling member 521 relative to the second plate 508 in response to expansion of the battery 502. Further, the washers 524 are configured to compress the elastic members 514 in response to compression plate 512 applying force against the washer 524 toward the first plate 506. Thus, when a battery 502 is arranged between the battery 502 and the second plate 508, the force from the compression plate 512 causes the elastic members 514 (and/or the air bladder 515) to compress, until a surface 513 of the compression plate 512 makes contact with a surface 517 of one or more spacers 516. In some examples, the amount of compression of the elastic members 514 corresponds to a desired amount of compression, pressure, and/or size of the air bladder 515, which in turn compresses the battery 502. As shown, the air bladder 515 and the battery 502 occupy a space 526 between plates.

In some examples, the compression plate 512 includes one or more openings 520 corresponding with a bolt or bolt head 522 of the coupling member 521. This arrangement allows the compression plate 512 to fully compress the elastic members 514 and the air bladders 515, while providing access to each bolt 522.

Thus, with the compression plate 512 in place and the elastic members 514 and air bladders 515 at a desired compression amount, the bolts 522 can be manipulated (e.g., tightened and/or loosened) to drive the coupling members 521 into the first and/or second plates 506, 508 to secure the coupling members 521 to the second plate 508 (e.g., via threaded bores), thereby fixing the relative positions of the first and second plates.

Each bolt 522 can be tightened or loosened independently. Thus, the air bladder 515 can be compressed independently to set an applied pressure on the battery 502 to reduce variations in pressure across the battery 502 due to expansion and/or contraction of the battery 502. In some examples, the distance between the compression plate 512 and the first plate 506, the distance between the first plate 506 and the second plate 508, and/or a height of the air bladder 515, for example, can be measured with calipers to ensure consistency. Additionally, or alternatively, the use of the compression plate 512 to apply a consistent force against the air bladder 515 may ensure a desired amount of compression.

The battery 502 and the air bladder 515 thus occupy the space 526, with the battery 502 providing a force pushing against the air bladder 515 and the first plate 506 during expansion. In particular, the first plate 506 is configured to allow for movement relative to the second plate 508 in a substantially vertical direction. As disclosed herein, as the battery 502 expands or contracts during cycling, which can compress the air bladder 515, pressing against the first plate 506 causing movement thereof, guided by the one or more coupling members 521 extending through one or more bore holes 520 of the first plate 506.

As shown in the example of FIGS. 5A and 5B, the spacers 516 are a generally rectangular-shaped structure, with one or more walls (e.g., internal and/or external walls), arranged on a surface 505 of the first plate 506 and configured to fully or partially cross a width of the first plate 506. However, the spacers 516 can have any size or geometry suitable to support the first plate 506 (e.g., cylindrical, U-shaped, L-shaped, etc.). As shown, the spacers 516 are arranged between two or more of the coupling members 521 and/or the elastic members 514. In some examples, one or more of the spacers 516 is arranged to fully or partially cross a length of the first plate 506.

The dimensions of the spacers 516 (e.g., height, placement relative to the elastic members 514, etc.) can vary based on one or more factors (e.g., amount of compression required, type of battery, particular application, etc.). In some examples, the spacers 516 are fixed to the surface 505. In some examples, the spacers 516 are removable from the surface 505. In some examples, the spacers 516 are fixed to the surface 513 of the compression plate 512.

In some examples, a fourth base plate 510 is provided to support the second plate 508, arranged adjacent a surface 509 of the second plate 508 opposite the battery 502. The base plate 510 may include one or more openings 528 to accommodate extension of coupling members 521 beyond the surface 509.

During a clamping operation, a device to apply a compressive force, such as a hydraulic press, can be used to evenly compress the elastic members via the compression plate. As the dimensions of the spacers are designed to correspond to a desired pressure, when the washers (e.g., forced toward the first plate in response to the compressive force applied by the compression plate) are substantially aligned with a height of the spacers, the desired compression of the elastic members is reached. Thus, the coupling members are tightened (e.g., in a cross pattern), resulting in a desired space in which the battery is contained.

In an example clamping device employing eight elastic members, the increased number of elastic members aids in a uniform pressure distribution and force distribution along edges of the opposing plates.

An advantage of the clamping device that allows for applied pressure adjustment (e.g., adjustable clamping device) can be seen by comparing the electrochemical cells that were cycled in the adjustable clamping devices with the cells that were cycled in fix-gap clamping devices. When a fix-gap clamping device is used, the multilayer battery is confined in a fixed space. As the layers of the battery expand during cycling, the force/pressure exerted on the battery would quickly increase with increasing expansion. Expansion during cycling is typically not uniform, resulting in a thickness variation of across the battery, which may result in non-uniform pressure exerted on the battery. For example, a group of electrochemical cells cycling with a fixed-gap clamping device had a greater deviation in discharge capacity, while a group of electrochemical cells cycling with the disclosed clamping device a much lower deviation of discharge capacity.

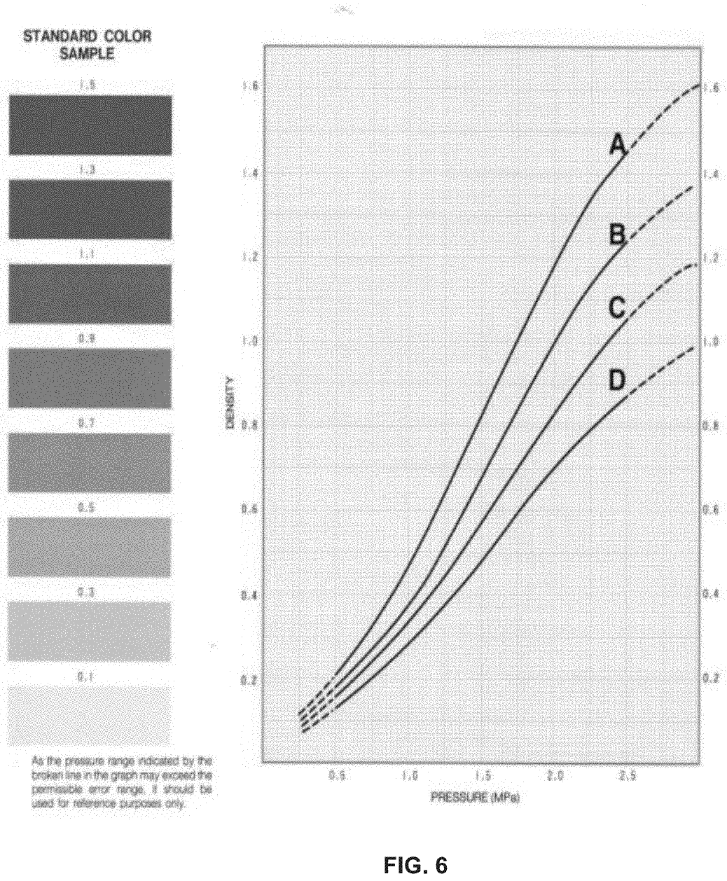

In some examples, experimental data confirms the effectiveness of the disclosed clamping device in uniform pressure distribution across a contained multilayer batter. For instance, in an example procedure, pressure profiling papers (e.g., Tactile Pressure Indicating Sensor Film) was placed adjacent to both sides of the battery surface. Pressure distribution is profiled based on a gradient of color (e.g., red), where a darker or deeper color represents areas exposed to a high pressure, and lighter color corresponds to less pressure. In the following examples 1-4, the pressure profiling papers were used to sandwich the cell between the first and second clamping plates. According to the specifications of the pressure profile paper, the pressure was acquired from the illustrated B curve (e.g., at a temperature of 25 C, relative humidity of 60%) as provided in FIG. 6.

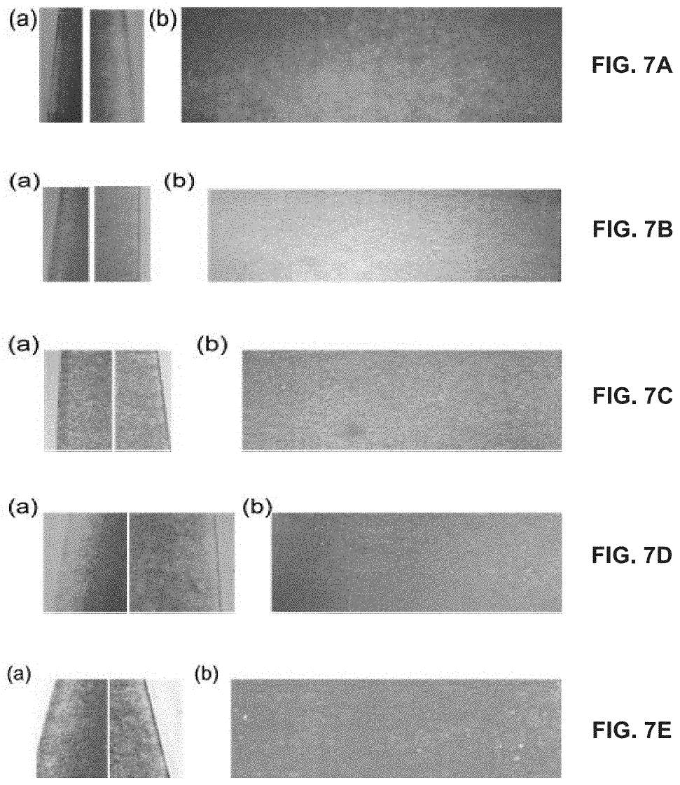

In the example illustrated in FIG. 7A, a multilayer battery is clamped between 12 pressure profiling papers (e.g., 6 papers on each side of the battery and the first and second plates). In this experiment, the clamping device employed 4 springs to provide pressure on the cell surface (see, e.g., FIGS. 1A and 1B).

After applying the pressure, the pressure profiling papers showed non-uniform pressure distribution on the battery surface. For instance, the center and tab corners of the battery presented substantial variations in coloration, indicating a non-uniform pressure distribution across the battery surface. Thus, as shown in FIG. 7A, the battery cell tab presented in sample a) and the center of the battery presented in sample b) were subjected to less pressure compared with the other areas of the cell surface.

In the example illustrated in FIG. 7B, a multilayer battery is clamped between 24 pressure profiling papers (e.g., 12 papers on each side of the battery and the first and second plates). In this experiment, the clamping device employed 4 springs to provide pressure on the cell surface (see, e.g., FIGS. 1A and 1B). As shown in FIG. 7B, the samples a) and b) show some improvement over the example of FIG. 7A, indicating adding additional papers provides enhanced pressure distribution.

In the example illustrated in FIG. 7C, a multilayer battery is clamped between 48 pressure profiling papers (e.g., 24 papers on each side of the battery and the first and second plates). In this experiment, the clamping device employed 4 springs to provide pressure on the cell surface (see, e.g., FIGS. 1A and 1B). As shown in FIG. 7C, the samples a) and b) show additional improvement over the examples of FIGS. 7A and 7B, indicating adding additional papers provides enhanced pressure distribution.

In the example illustrated in FIG. 7D, a multilayer battery is clamped between 24 pressure profiling papers (e.g., 12 papers on each side of the battery and the first and second plates). In this experiment, although fewer papers are being used in comparison the examples shown in FIGS. 7B and 7C, the clamping device in this experiment employed 8 springs to provide pressure on the cell surface (see, e.g., FIGS. 2A and 2B). As shown in FIG. 7D, the samples a) and b) show additional improvement over the examples of FIGS. 7A-7C, indicating adding additional papers provides enhanced pressure distribution.

In the example illustrated in FIG. 7E, a multilayer battery is clamped between 48 pressure profiling papers (e.g., 24 papers on each side of the battery and the first and second plates). Thus, in this experiment, a greater number of papers are being than the experiment of FIG. 7D, while employing a clamping device with 8 springs to provide pressure on the cell surface (see, e.g., FIGS. 2A and 2B). As shown in FIG. 7D, the samples a) and b) show significant improvement over the examples of FIGS. 7A-7D, indicating adding additional papers provides enhanced pressure distribution.

Accordingly, the experimental data confirms that pressure distribution can be optimized by modifying the number of interfacial layers employed between the battery and the plates contributes to a more uniform pressure distribution at the corners, while increasing a number of elastic members (e.g., here, to 8 springs) in the clamped device facilitates more even distribution at the center of the battery.

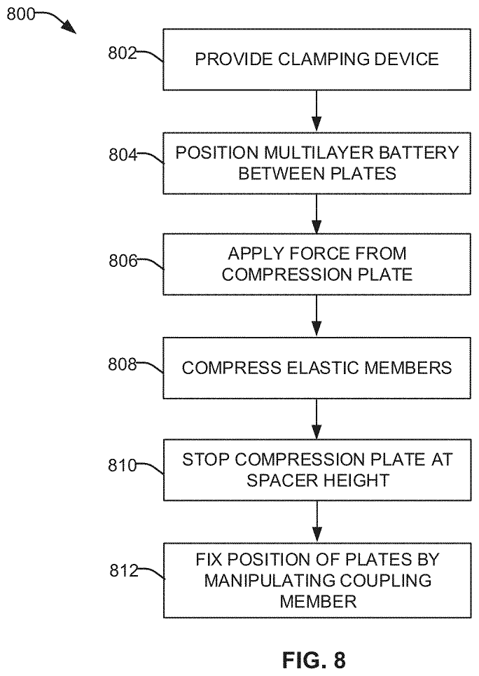

FIG. 8 illustrates an example method of reducing deformation of an electrode or current collector in an electrochemical cell stack. In the example method 800, as shown in block 802, the method 800 can include providing a clamping device (e.g., clamping device 100, 200). In block 804, a multilayer battery (e.g., battery 102, 202) is positioned between a first and a second plate (e.g., first plate 106, 206, and second plate 108, 208). In block 806, a compression plate (e.g., compression plate 112, 212) applies a force against one or more washers (e.g., washers 124, 214). In block 808, the force from the compression plate compresses one or more elastic members (e.g., elastic members 114, 214), the compression plate stopping on one or more spacers (e.g., spacers 116, 216) as shown in block 810.

Once the elastic members have reached a level of compression corresponding to the spacers, in block 812 a coupling member (e.g., coupling member 121, 221) is manipulated to fix a position and/or pressure on the multilayer battery between the first and second plates. For instance, the applied pressure on the multilayer battery can be set to help compensate for non-uniform thickness variation during cycling of the multilayer battery. As a result, the amount of warping and deformation of the multilayer battery can be reduced.

Additionally, it is possible to include more than one multilayer battery per clamping device. For example, more than one multilayer battery can be placed side by side or in multiple layers, as long as the pressure on the multilayer battery can be maintained. Thus, positioning the multilayer battery between the first and second plates can include positioning a second cell stack between the first and second plates.

In some methods, the timing of the use of the clamping device can be important. For example, in order to reduce electrode or current collector foil deformation, the multilayer battery may be clamped before the first charge occurs (e.g., also known as formation charge). Moreover, clamping of the multilayer battery may aid in absorbing cell constituent components in addition to mitigating deformation. In some examples, if the clamping device is used for the first time after the first formation charge occurs, one or more layers of the multilayer battery may irreversibly deform (e.g., may be unable to return to its original geometry). Thus, in certain examples, the method 800 can further include positioning the multilayer battery between the first and second plates prior to charging the multilayer battery for the first time.

Cell formation (e.g., for one or more layers of the multilayer battery) occurs when the cell(s) is treated after building the cell (e.g., to help the cell perform well throughout its life). Many times, cell formation can refer to the first charge of a cell. In some instances, the cell formation procedure can be more complicated. For example, cell formation can include charging of the cell at a rate of C/20, cycling the cell three times by charging at the rate of C/2, holding the voltage at the charge voltage (e.g., 4.2 V) until the current drops to C/20, and then discharging at the rate of C/5. These types of procedures can be done while the cell is clamped with certain embodiments described herein. For pouch or can cells with a good polymer adhesion technology, the clamping device can be removed after the pre-treatment of the cell is finalized. For pouch or can cells without sufficient polymer adhesion technology, the clamping device can remain on the cell, e.g., the applied pressure could be the same as during the pre-treatment or can be reduced. Other cell pre-treatment conditions that may be used before removing the clamping device includes treatments to the cell that include heating, pressing, and or heating and pressing.

As described herein, overly high pressure on portions of a cell damages the cell, increasing the frequency and/or severity of failures such as shorting and/or rupture of the cell. Force (e.g., applied pressure) on the cells of the multilayer battery as a function of cell expansion during the cycling in an adjustable clamp can be compared to cycling in a fix-gap clamp. For example, as the cell stack expands during charging, the force (and thus, pressure) exerted on the cell stack by the clamping device increases quickly (varies significantly) upon expansion.

In disclosed examples, the clamping device with a positionable plate ensures the force increase is linear, rather than substantially exponential as is the case for a fixed spacing clamp device. Thus, as the cell expands during charging, the increase of the force exerted on the cell stack is much slower (slightly varies) compared to that of the cell in a fix-gap clamping device. In some examples, the increase in the force is substantially linear, albeit gradual. In other examples, the force on the cell stack could be substantially constant during cell expansion.

In some instances, the increase in applied pressure on the multilayer battery can be reduced such that the applied pressure varies slightly or becomes substantially constant upon cell expansion. Reductions in the increase in applied pressure can beneficially result in a more consistent electrochemical behavior.

As described herein, clamping devices can reduce the amount of warping and deformation on the electrode or current collector foil by reducing and/or slowing the pressure exerted by the plates, and/or by reducing the variation in the applied pressure due to the expansion of the multilayer battery. The amount or severity of deformation on the cells could be greatly minimized during cycling. In some examples, the clamping device is designed to be left on the battery for extended use, without substantially affecting the cycle life of the battery. The disclosed advantages are realized by electrochemical cells containing silicon-based electrodes as well as graphite electrochemical cells.

In examples, cell, battery, and/or layer uniformity can be defined as the thickness of the battery at one or more locations across an area of the battery's surface. By employing the clamping device(s) disclosed herein, non-uniformity of the battery can be limited, ranging from less than 25% of the surface area of the battery to less than 75% of the surface area.

In some examples, the battery the thickness of the battery between the interfacial material is substantially uniform, such that thickness non-uniformity of the battery is less than 70% in some instances. In some examples, non-uniformity of the battery is less than 50%, less than 30%, or less than 25%. The amount of non-uniformity can be controlled by the type and/or thickness of the interfacial material. In some examples, the compressibility of the battery is a factor of the compressibility of the interfacial material (e.g., how much compression occurs in the interfacial material versus the battery) when subject to given pressure (e.g., from the compression plate and/or in response to expansion of the battery). The compressibility may be less than 70%, less than 50%, less than 30%, or less than 25%. In some examples, the measure of non-uniformity includes battery surface non-uniformity and the amount of expansion in the battery itself (e.g., maintained below 70%, 50%, 30%, or 25%).

In some examples, pressure is applied to multiple batteries at once, and the combined total non-uniformity of the multiple batteries and/or swelling is determined by a given ratio versus a combined interfacial material layer thicknesses (e.g., the interfacial material arranged between the batteries and one or more plates, and/or between another battery), or a total amount of compression of the interfacial material layer. In some examples, the ratio of interfacial material layer or interfacial material layer compressibility to the battery non-uniformity and/or swelling allows for an estimated profile of applied pressure to be within approximately 100-200 psi, 100 psi, 75 psi, or 50 psi, or approximately less than 70%, less than 50%, less than 30%, or less than 25% of an amount of the initially applied pressure.

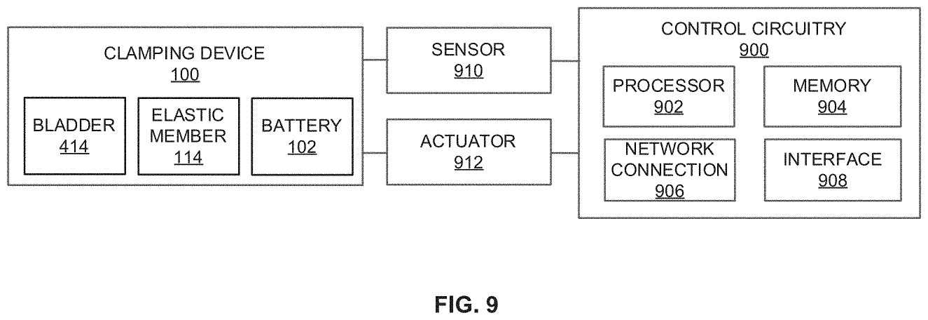

In the example of FIG. 9, a circuit, analog or digital controller, computer and/or control circuitry 900 is used during operation to control the average pressure and/or control the uniformity of pressure. As shown, the control circuitry 900 can include a processor 902, a memory 904, a network connection or interface 906, and/or human/machine interface 908, and physically and/or electrically connect with one or more of a sensor 910 (e.g., pressure or force sensor, optical sensor, thermistor, etc.), an actuator 912 (e.g., a pneumatic or hydraulic piston, a mechanical force device, etc.), and/or a clamping device (e.g., clamping device 100, 200, 300, 400, 500), which may include a direct connection with a multilayer battery (e.g., battery 102, 202, 302, 402, 502).

In some examples, the average pressure and/or uniformity of pressure is controlled by adjusting the compression of the elastic member(s) (e.g., elastic members 114, 214, 514). In some examples, the average pressure and/or uniformity of pressure is controlled by adjusting the compression of the bladder(s) (e.g., 314, 414, 515). For instance, a sensor 910 or other device may be configured to monitor one or more characteristics of the device (e.g., a position of one or more plates, a pressure level, etc.) or a change thereof, and transmit the information to the control circuitry 900. The control circuitry 900 can calculate a change in the one or more characteristics (e.g., a rate of change, and absolute change, a difference with regard to an initial or threshold value, etc.), and control the actuator 912 to implement a change in a component of the device (e.g., the bladder, the elastic member, etc.) to adjust the one or more characteristics. In some embodiments, multiple air bladders and/or elastic members are controlled to adjust pressure uniformity and average pressure.

In some examples, the disclosed bladders and/or elastic members are substituted with the actuator 912, which is configured to adjust the average pressure and pressure uniformity against the battery (e.g., during cell formation, cycling, operation, etc.). In such an example, the actuator 912 can be one or more of a spring, a plunger, an elastic band, a pneumatic or hydraulic piston, a pneumatic or hydraulic bladder, a motorized screw or piston, or foam. The control circuitry 900 is configured to control such an actuator to selectively apply pressure to one or more of the compression plate, the first plate, the second plate, the stabilizing plate, and/or directly against the battery. The actuator 912 may be a single actuator or multiple actuators, for instance, corresponding to different locations across a surface of the battery, thereby configured to apply pressure selectively across the battery in response to changes in the pressure, such as determined by a sensor input.

In some examples, the average pressure and pressure uniformity is controlled within a module or pack. One such example would be using a controller along with a sensor to continually adjust the pressure within an electric vehicle module or pack. The pressure could be controlled such that the pressure does not deviate 30%, 20%, 10%, 5%, or 1% from the intended pre-determined pressure curve tied to State of Health (SOH) and State of Charge (SOC). In other cases, the pressure could be controlled such that the pressure does not deviate 90%, 50%, 30%, 20%, 10%, 5% from the initial pressure.

An example clamping device for forming or operating a battery, in accordance with the present disclosure, includes a first plate positionable relative to a second plate such that a space between the first plate and the second plate is sized to receive the battery, an interfacial material arranged between the battery and the first plate or the second plate, the interfacial material configured to conform to a surface of the battery, a coupling member coupling the first plate to the second plate, the coupling member having a first end portion and a second end portion, one or more elastic members disposed between the first end portion and the second end portion, and a compression plate to apply a compressive force to compress the one or more elastic members to a predetermined length.

In an example implementation, one or both of the first plate and the second plate is movable away from the other plate about the coupling member in response to expansion of the battery.

In an example implementation, at least one of the end portions of the coupling member is configured to set an applied pressure on the battery corresponding to the elastic members to the predetermined length.

In an example implementation, the elastic member is configured to be compressed during cycling of the battery, thereby reducing variations in pressure on the battery due to the expansion of the battery to reduce deformation of an electrode in the battery upon cycling.

In an example implementation, the elastic member comprises one or more of a spring, a plunger, an elastic band, a pneumatic or hydraulic piston, a pneumatic or hydraulic bladder, or foam.

In an example implementation, the coupling member comprises a fastener, a spring clamp, or a C-clamp.

In an example implementation, the interfacial material comprises polyethylene sheet, polypropylene sheet, PTFE sheet, paper, paperboard, natural rubber, silicone rubber, reinforced (such as fiber) polymer (such as rubber), foam, a pneumatic or hydraulic bladder, or felt.

In an example implementation, the first plate, the second plate, or the compression plate have thicknesses between about 0.5 cm and about 0.8 cm.

In an example implementation, at least one of the first plate, the second plate, or the compression plate comprises one or more of a metal or an insulator.

In an example implementation, the compressive force applied by the compression plate is between about 25 psi and about 350 psi.

In an example implementation, the compressive force applied by the compression plate is between about 25 psi and about 250 psi.

In an example implementation, the compressive force applied by the compression plate is between about 50 psi and about 200 psi.

In an example implementation, the battery is a first battery, the device further comprising a second battery, wherein both the first battery and the second battery are arranged between the first and second plates.

In an example implementation, the clamping device is a first clamping device comprising a first battery, the first battery of the first clamping device configured to electrically connect with a second battery of a second clamping device.

In an example implementation, one or more spacers are arranged between the first plate and the compression plate, the one or more spacers configured to determine a distance at which the compression plate stops, corresponding to an amount of compression of the elastic members.

In an example implementation, the device is used to apply pressure against an expanding battery to uniformly distribute pressure across an area of the battery with a profile of applied pressure within 100-200 psi or less than 70% of an initially applied pressure.

In an example implementation, the battery is a multilayer battery comprising one or more electrodes including a silicon-containing or silicon-dominant anode and a separator, the profile of applied pressure resulting in few or no gaps between the one or more electrodes or the separator of the multilayer battery.

In an example implementation, the clamping device is one of a plurality of clamping devices arranged in a pack, one or more batteries of the plurality of clamping devices being electrically connected with another battery of another clamping device.

In an example implementation, the batteries within the pack are configured to provide energy stored within the batteries to an electric vehicle.

In an example implementation, one or more characteristics of the device is monitored by one or more sensors connected to control circuitry, the control circuitry configured to control pressure or pressure uniformity across an area of the battery in real-time in response to a change in the one or more characteristics.

Another example clamping device for forming or operating a battery, in accordance with the present disclosure, includes a first plate positionable relative to a second plate such that a space between the first plate and the second plate is sized to receive the battery, an interfacial material arranged between the battery and the first plate or the second plate, the interfacial material configured to conform to a surface of the battery, a coupling member coupling the first plate to the second plate, the coupling member having a first end portion and a second end portion, and an actuator configured to apply a compressive force against the first plate or the second plate to set the space at a predetermined length.

In an example implementation, the actuator comprises one or more pneumatic bladders, such that one or more pneumatic bladders are configured to adjust internal pressure independent of another bladder.

In an example implementation, the pneumatic bladders are configured to be compressed by another actuator configured to control pressure within the pneumatic bladders.

In an example implementation, a compression plate, wherein the actuator is arranged between the compression plate and the first plate, such that a compressive force applied against the actuator by the compression plate forces the first plate toward the second plate.

In an example implementation, the actuator is configured to be compressed during the charging of the battery in response to expansion of the battery.

In an example implementation, the actuator is one or more of a spring, a plunger, an elastic band, a pneumatic or hydraulic piston, a pneumatic or hydraulic bladder, a motorized screw or piston, or foam.

In an example implementation, one or more characteristics of the device is monitored by one or more sensors connected to control circuitry, the control circuitry configured to control the actuator to adjust pressure or pressure uniformity across an area of the battery in real-time in response to a change in the one or more characteristics.

An example interfacial material arranged within a clamping device for reducing deformation in a multilayer battery, in accordance with the present disclosure, includes a first plate positionable relative to a second plate such that a space between the first plate and the second plate is sized to receive the battery, wherein the interfacial material is arranged between the battery and the first plate or the second plate, the interfacial material configured to conform to a surface of the battery, a coupling member coupling the first plate to the second plate, the coupling member having a first end portion and a second end portion, one or more elastic members disposed between the first end portion and the second end portion, and a compression plate to apply a compressive force to compress the one or more elastic members to a predetermined length.

In an example implementation, the battery is positioned between the first plate and the second plate prior to charging the battery for the first time.

In an example implementation, the interfacial material comprises one or more of polyethylene sheet, polypropylene sheet, PTFE sheet, paper, paperboard, natural rubber, silicone rubber, reinforced polymer, reinforced fiber, reinforced polymer, foam, a pneumatic or hydraulic bladder, or felt.

In an example implementation, the interfacial material comprises two or more layers.

In an example implementation, the battery comprises a silicon anode.

In an example implementation, the battery comprises an anode comprising graphite.

In an example implementation, the battery is a lithium ion battery.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A clamping device for forming or operating a battery, the clamping device comprising:
a first plate positionable relative to a second plate such that a space between the first plate and the second plate is sized to receive the battery;
an interfacial material arranged between the battery and the first plate or the second plate, the interfacial material configured to conform to a surface of the battery;
a coupling member coupling the first plate to the second plate, the coupling member having a first end portion and a second end portion;
one or more elastic members disposed between the first end portion and the second end portion; and
a compression plate to apply a compressive force to compress the one or more elastic members to a predetermined length.

2. The clamping device of claim 1, wherein one or both of the first plate and the second plate is movable away from the other plate about the coupling member in response to expansion of the battery.

3. The clamping device of claim 1, wherein at least one of the end portions of the coupling member is configured to set an applied pressure on the battery corresponding to the elastic members to the predetermined length.

4. The clamping device of claim 1, wherein the elastic member is configured to be compressed during cycling of the battery, thereby reducing variations in pressure on the battery due to the expansion of the battery to reduce deformation of an electrode in the battery upon cycling.

5. The clamping device of claim 1, wherein the elastic member comprises one or more of a spring, a plunger, an elastic band, a pneumatic or hydraulic piston, a pneumatic or hydraulic bladder, or foam.

6. The clamping device of claim 1, wherein the coupling member comprises a fastener, a spring clamp, or a C-clamp.

7. The clamping device of claim 1, wherein the interfacial material comprises polyethylene sheet, polypropylene sheet, PTFE sheet, paper, paperboard, natural rubber, silicone rubber, reinforced (such as fiber) polymer (such as rubber), foam, a pneumatic or hydraulic bladder, or felt.

8. The clamping device of claim 1, wherein the first plate, the second plate, or the compression plate have thicknesses between about 0.5 cm and about 0.8 cm.

9. The clamping device of claim 1, wherein at least one of the first plate, the second plate, or the compression plate comprises one or more of a metal or an insulator.

10. The clamping device of claim 1, wherein the compressive force applied by the compression plate is between about 25 psi and about 350 psi.

11. The clamping device of claim 1, wherein the compressive force applied by the compression plate is between about 25 psi and about 250 psi.

12. The clamping device of claim 1, wherein the compressive force applied by the compression plate is between about 50 psi and about 200 psi.

13. The clamping device of claim 1, wherein the battery is a first battery, the device further comprising a second battery, wherein both the first battery and the second battery are arranged between the first and second plates.

14. The clamping device of claim 1, wherein the clamping device is a first clamping device comprising a first battery, the first battery of the first clamping device configured to electrically connect with a second battery of a second clamping device.

15. The clamping device of claim 1, further comprising one or more spacers arranged between the first plate and the compression plate, the one or more spacers configured to determine a distance at which the compression plate stops, corresponding to an amount of compression of the elastic members.

16. The clamping device of claim 1, wherein the device is used to apply pressure against an expanding battery to uniformly distribute pressure across an area of the battery with a profile of applied pressure within 100-200 psi or less than 70% of an initially applied pressure.

17. The clamping device of claim 1, wherein the battery is a multilayer battery comprising one or more electrodes including a silicon-containing or silicon-dominant anode and a separator, the profile of applied pressure resulting in few or no gaps between the one or more electrodes or the separator of the multilayer battery.

18. The clamping device of claim 1, wherein the clamping device is one of a plurality of clamping devices arranged in a pack, one or more batteries of the plurality of clamping devices being electrically connected with another battery of another clamping device.

19. The clamping device of claim 18, wherein the batteries within the pack are configured to provide energy stored within the batteries to an electric vehicle.

20. The clamping device of claim 1, wherein one or more characteristics of the device is monitored by one or more sensors connected to control circuitry, the control circuitry configured to control pressure or pressure uniformity across an area of the battery in real-time in response to a change in the one or more characteristics.

21. A clamping device for forming or operating a battery, the clamping device comprising:
a first plate positionable relative to a second plate such that a space between the first plate and the second plate is sized to receive the battery;
an interfacial material arranged between the battery and the first plate or the second plate, the interfacial material configured to conform to a surface of the battery;
a coupling member coupling the first plate to the second plate, the coupling member having a first end portion and a second end portion; and
an actuator configured to apply a compressive force against the first plate or the second plate to set the space at a predetermined length.

22. The clamping device of claim 21, wherein the actuator comprises one or more pneumatic bladders, such that one or more pneumatic bladders are configured to adjust internal pressure independent of another bladder.

23. The clamping device of claim 22, wherein the pneumatic bladders are configured to be compressed by another actuator configured to control pressure within the pneumatic bladders.

24. The clamping device of claim 21, further comprising a compression plate, wherein the actuator is arranged between the compression plate and the first plate, such that a compressive force applied against the actuator by the compression plate forces the first plate toward the second plate.

25. The clamping device of claim 21, wherein the actuator is configured to be compressed during the charging of the battery in response to expansion of the battery.

26. The clamping device of claim 21, wherein the actuator is one or more of a spring, a plunger, an elastic band, a pneumatic or hydraulic piston, a pneumatic or hydraulic bladder, a motorized screw or piston, or foam.

27. The clamping device of claim 21, wherein one or more characteristics of the device is monitored by one or more sensors connected to control circuitry, the control circuitry configured to control the actuator to adjust pressure or pressure uniformity across an area of the battery in real-time in response to a change in the one or more characteristics.

28. An interfacial material arranged within a clamping device for reducing deformation in a multilayer battery, wherein the clamping device comprises:
a first plate positionable relative to a second plate such that a space between the first plate and the second plate is sized to receive the battery, wherein the interfacial material is arranged between the battery and the first plate or the second plate, the interfacial material configured to conform to a surface of the battery;
a coupling member coupling the first plate to the second plate, the coupling member having a first end portion and a second end portion;
one or more elastic members disposed between the first end portion and the second end portion; and
a compression plate to apply a compressive force to compress the one or more elastic members to a predetermined length.

29. The interfacial material of claim 28, wherein the battery is positioned between the first plate and the second plate prior to charging the battery for the first time.

30. The interfacial material of claim 28, wherein the interfacial material comprises one or more of polyethylene sheet, polypropylene sheet, PTFE sheet, paper, paperboard, natural rubber, silicone rubber, reinforced polymer, reinforced fiber, reinforced polymer, foam, a pneumatic or hydraulic bladder, or felt.

31. The interfacial material of claim 28, wherein the interfacial material comprises two or more layers.

32. The interfacial material of claim 28, wherein the battery comprises a silicon anode.

33. The interfacial material of claim 28, wherein the battery comprises an anode comprising graphite.

34. The interfacial material of claim 28, wherein the battery is a lithium ion battery.
